(19) United States
(12) Patent Application Publication
(10) Pub. No.: US 2008/0253955 A1
(43) Pub. Date: Oct. 16, 2008

(54) Process and apparatus for purifying low-grand silicon material

(75) Inventors: Dominic Leblanc, Becancour (CA); Rene Boisvert, Trois-Rivieres (CA)

Correspondence Address: MERCHANT & GOULD PC, P.O. BOX 2903, MINNEAPOLIS, MN, 55402-0903, US

(73) Assignee: Silicium Becancour Inc., Becancour (CA)

(21) Appl. No.: 11/901,146

(22) Filed: Sep. 13, 2007

Related U.S. Application Data
(60) Provisional application No. 60/844,372, filed on Sep. 14, 2006.

(51) Int. Cl. C01B 33/037

(52) U.S. Cl. 423/350

(57) ABSTRACT

A process and apparatus for purifying low-purity silicon material and obtaining a higher-purity silicon material is provided. The process includes providing a melting apparatus equipped with an oxy-fuel burner, and melting the low-purity silicon material in the melting apparatus to obtain a melt of higher-purity silicon material. The melting apparatus may include a rotary drum furnace and the melting of the low-purity silicon material may be carried out at a temperature in the range from 1410° C. to 1700° C. under an oxidizing or reducing atmosphere. A synthetic slag may be added to the molten material during melting. The melt of higher-purity silicon material may be separated from a slag by outpouring into a mould having an open top and insulated bottom and side walls. Once in the mould, the melt of higher-purity silicon material can undergo controlled unidirectional solidification to obtain a solid polycrystalline silicon of an even higher purity.

### FIELD OF THE INVENTION

The present invention generally relates to the production of silicon. More particularly, the invention relates to a process and apparatus for purifying low-grade silicon material to obtain higher-grade silicon for use in photovoltaic or electronic applications.

### BACKGROUND OF THE INVENTION

There are many and varied applications of silicon (Si), each application with its own particular specifications.

Most of the world production of metallurgical grade silicon goes to the steel and automotive industries, where it is used as a crucial alloy component. Metallurgical grade silicon is a silicon of low purity. Typically, metallurgical grade silicon that is about 98% pure silicon is produced via the reaction between carbon (coal, charcoal, pet coke) and silica (SiO₂) at a temperature around 1700° C. in a process known as carbothermal reduction.

A small portion of the metallurgical grade Si is diverted to the semiconductor industry for use in the production of Si wafers, etc. However, the semiconductor industry requires silicon of ultra-high purity, e.g. electronic grade silicon (EG-Si) having approximately a 99.9999999% purity (9N). Metallurgical grade silicon must be purified to produce this electronic grade. However, the purification process is elaborate resulting in the higher cost of electronic grade silicon.

The photovoltaic (PV) industry requires silicon of a relatively high degree of purity for the production of photovoltaic cells, i.e. solar cells. The purity requirements of silicon for best performance in solar cell applications are:
boron (B)<3 ppm,
phosphorus (P)<10 ppm,
total metallic impurities<300 ppm and preferably <150 ppm.

Although the degree of silicon purity required by the photovoltaic industry is less than that of the semiconductor industry, an intermediate grade of silicon, i.e. solar grade (SoG-Si) silicon, with the necessary low boron and low phosphorus content is not readily commercially available. One current alternative is to use expensive ultra-high purity electronic grade silicon; this yields solar cells with efficiencies close to the theoretical limit but at a prohibitive price. Another alternative is to use less expensive “scrap” or off-specification supply of electronic grade silicon from the semiconductor industry. However, improvements in silicon chip productivity have resulted in a decrease in the “scrap” supply of electronic grade silicon available to the PV industry. Moreover, parallel growth of the semiconductor and photovoltaic industries has also contributed to the general short supply of electronic grade silicon.

Several methods of purifying low-grade silicon, i.e. raw silicon or metallurgical grade silicon, are known in the art.

US Patent Application No. 2005/0074388 describes a medium purity silicon to be used as a raw material for making electronic quality or photovoltaic quality silicon and the process for making this material. The process involves the production of a silicon with a low boron content by carbothermal reduction of silica in a submerged electric arc furnace. The liquid silicon thus produced is poured in ladles, refined by injecting oxygen or chlorine using a graphite rod, placed under a bell housing and treated under reduced pressure with neutral gas injection, and then poured into a mould placed in a furnace to solidify in a controlled fashion and cause segregation of impurities in the residual liquid. The refining of the liquid silicon by oxygen injection cannot take place safely in an electric arc furnace. As such, the refining procedure of the liquid silicon by oxygen injection requires the transfer of the liquid silicon form the furnace to a ladle, adding additional practical steps to the process and thus complexity.

U.S. Pat. Nos. 3,871,872 and 4,534,791 describe the treatment of silicon with a slag to remove calcium (Ca) and aluminum (Al) impurities. In particular, U.S. Pat. No. 3,871,872 describes adding a slag comprising SiO₂ (silica), CaO (lime), MgO (magnesia) and Al₂O₃ (alumina) to molten silicon metal and U.S. Pat. No. 4,534,791 describes treating silicon with a molten slag comprising SiO₂ (silica), CaO (lime), MgO (magnesia) and Al₂O₃ (alumina), Na₂O, CaF₂, NaF, SrO, BaO, MgF₂, and K₂O.

In the article “Thermodynamics for removal of boron from metallurgical silicon by flux treatment of molten silicon” by Suzuki and Sano published in the proceedings of the 10th European photovoltaic solar energy conference in Lisbon, Portugal, 8-12 Apr. 1991, removal of boron by flux or slag treatment is investigated. It was found that treatment of silicon with the slag systems CaO—SiO₂, CaO—MgO—SiO₂, CaO—BaO—SiO₂ and CaO—CaF₂—SiO₂ gave a maximum distribution coefficient of boron (L_{B}), defined as the ratio between ppmw B in slag and ppmw B in silicon, of about 2.0 when the slag system CaO—BaO—SiO₂ was used. As illustrated in FIG. 1, it was further found that the boron distribution coefficient increases with increasing alkalinity of the slag, reaches a maximum and then decreases. The experiments made by Suzuki and Sano were carried out by placing 10 g of silicon and 10 g of slag in a graphite crucible, melting the mixture and keeping the mixture molten for two hours. The low distribution coefficient of boron between slag and molten silicon means that a high amount of slag has to be used and that the slag treatment has to be repeated a number of times in order to bring the boron content from 20-100 ppm, which is the normal boron content of metallurgical silicon, down to below 1 ppm, which is the required boron content for solar grade silicon. The process described in the article of Sano and Suzuki is thus both very costly and time consuming.

Methods relying on the vaporization of suboxides have also been proposed for removing boron from silicon. Indeed, since 1956, when Theurer reported his work on zone melting of silicon, it has been known that silicon may be purified of boron by melting silicon in a flow of a weakly oxidizing gas mixture of Ar—H₂—H₂O—French patent FR 1469486 describes such a method.

European patent EP 0 756 014 describes a method of smelting aluminum and remainders containing aluminum in a rotary drum furnace having an oxy-fuel burner in order to reduce the volume of waste gases produced and the noxious content thereof.

It is also known in the art to melt steel in a rotary drum furnace equipped with an oxy-fuel burner.

However, it has never been seriously considered nor experimented to melt silicon in a furnace using an oxy-fuel burner.

Although efforts have been made to develop methods for purifying low grade or metallurgical grade silicon, there is still a need for a practical and cost-efficient method for purifying low grade silicon or metallurgical grade silicon to obtain higher-grade silicon for use in photovoltaic or electronic applications.

### SUMMARY OF THE INVENTION

An object of the present invention is to provide a process for purifying silicon that satisfies the above-mentioned needs.

In accordance with one aspect of the present invention, there is provided a process for purifying low-purity silicon material and obtaining a higher-purity silicon material.

The process includes the steps of:

(a) providing a melting apparatus equipped with an oxy-fuel burner; and
(b) melting the low-purity silicon material in the melting apparatus and obtaining a melt of higher-purity silicon material.

Preferably, the melting apparatus of step (a) includes a rotary drum furnace.

The melting of the low-purity silicon material in the melting apparatus may occur under an oxidizing atmosphere provided by the oxy-fuel burner.

The melting of step (b) may include setting an oxygen gas to natural gas fuel ratio in the range from 1:1 to 4:1.

The melting of step (b) may include melting the low-purity silicon material at a temperature in the range from 1410° C. to 1700° C.

The melting of step (b) may include adding a synthetic slag.

The melting of step (b) may comprise collecting silica fumes produced during the melting of the low-purity silicon material.

The process may further include a step of:

(c) separating the melt of higher-purity silicon material from a slag.

The separating of the melt preferably includes outpouring the melt into a mould having an insulated bottom wall, insulated side walls, and an open top.

According to one embodiment of the present invention, the process may further include the steps of:

(d) solidifying the melt of higher-purity silicon material by unidirectional solidification from the open top towards the insulated bottom wall of the mould while electromagnetically stirring the melt;
(e) controlling a rate of the unidirectional solidification;
(f) stopping the unidirectional solidification when the melt has partially solidified to produce an ingot having an exterior shell comprising a solid polycrystalline silicon having a purity higher than the higher-purity silicon material and a center comprising an impurity-enriched liquid silicon; and
(g) creating an opening in the exterior shell of the ingot to outflow the impurity-enriched liquid silicon and leave behind the exterior shell thereby obtaining a solid polycrystalline silicon having a purity higher than the higher-purity silicon material.

According to another embodiment of the present invention, the process may further include the steps of:

(d) solidifying the melt of higher-purity silicon material by unidirectional solidification while electromagnetically stirring the melt and obtaining a solid ingot;
(e) controlling a rate of the unidirectional solidification; and
(f) separating a first portion of the solid ingot from a remaining portion, the first portion having solidified before the remaining portion and having less impurities than the remaining portion, thus obtaining a solid polycrystalline silicon having a purity higher than the higher-purity silicon material.

In accordance with another aspect of the invention, there is provided a use of a rotary drum furnace equipped with an oxy-fuel burner for melting and purifying a lower purity silicon material and thereby obtaining a higher-purity silicon material.

While the invention will be described in conjunction with example embodiments, it will be understood that it is not intended to limit the scope of the invention to such embodiments. On the contrary, it is intended to cover all alternatives, modifications and equivalents as may be included as defined by the present description. The objects, advantages and other features of the present invention will become more apparent and be better understood upon reading of the following non-restrictive description of the invention, given with reference to the accompanying drawings.

### BRIEF DESCRIPTION OF THE DRAWINGS

FIG. 1 is a graph of the distribution coefficient of boron with the CaO/SiO₂ ratio of a CaO—CaF₂—SiO₂ slag system [Suzuki et al (1990)—Prior Art].

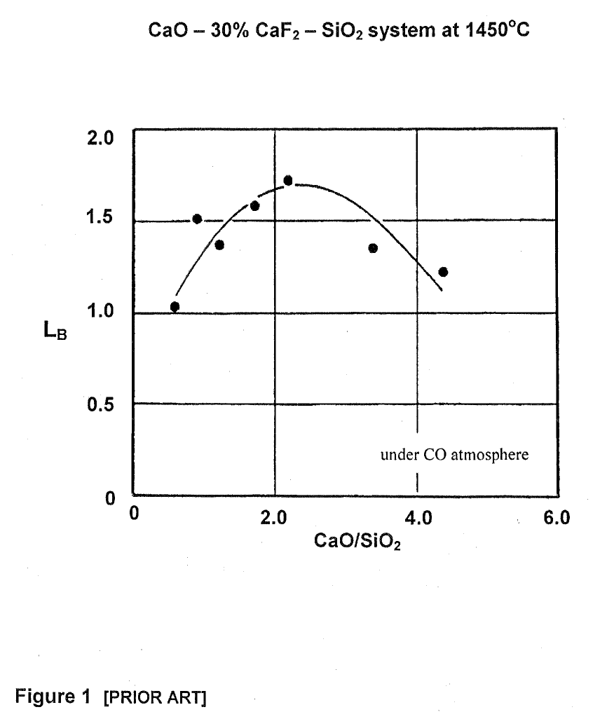

FIG. 2 is a cross-sectional view of a melting apparatus equipped with an oxy-fuel burner according to one embodiment of the present invention.

FIG. 3 is a graph of enthalpy versus temperature for elemental silicon [Prior Art].

FIG. 4 is a graph of flame temperature versus oxidizing-agent content of burner fuel.

FIG. 5 is a graph of oxy-fuel combustion product distribution as a function of oxygen content of oxy-fuel.

FIG. 6 is a schematic drawing showing an outpouring of a melt of silicon material from a rotary drum furnace into a mould according to one embodiment of the present invention.

FIG. 7 is a schematic drawing of a melt of silicon undergoing unidirectional solidification with electromagnetic stirring in an insulated open top mould.

### DETAILED DESCRIPTION OF THE INVENTION

As mentioned the present invention relates to the purification of low-grade silicon material to obtain higher-grade silicon for use in photovoltaic or electronic applications.

More specifically, in accordance with one aspect of the present invention, there is provided a process for purifying low-purity silicon material and obtaining a higher-purity silicon material. Basically, the process includes the steps of (a) providing a melting apparatus equipped with an oxy-fuel burner, and (b) melting the low-purity silicon material in the melting apparatus and obtaining a melt of higher-purity silicon material. These steps will be discussed more fully hereinafter.

(a) Providing a Melting Apparatus Equipped with an Oxy-Fuel Burner

To start, the expression “melting apparatus” refers to any enclosure that gives off heat, and includes a device that produces heat such as a furnace. As the expression connotes, a “melting apparatus” is any apparatus that may be used to melt material.

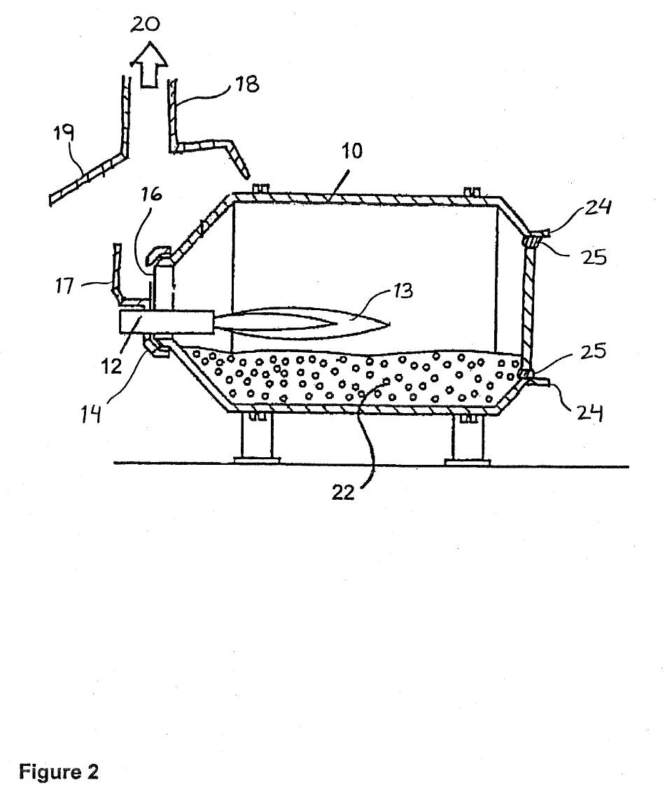

Any appropriate melting apparatus equipped with an oxy-fuel burner may be provided. One such example, shown in FIG. 2, is a rotary drum furnace 10 equipped with an oxy-fuel burner 12. Advantageously, a rotary drum furnace typically has a refractory lining which can resist damage caused by high temperature and can retain heat. Other examples of an appropriate melting apparatus include an induction furnace or electric arc furnace equipped with an additional oxy-fuel burner providing a desired oxidizing atmosphere.

According to the embodiment shown in FIG. 2, the rotary drum furnace 10 has a rotating cylindrical body. At one end of the rotary drum furnace 10, there is disposed an opening 16 provided with a door 14 through which the low-purity silicon material 22 may be loaded into the rotary drum furnace 10. The loading of the material may be carried out using a loading device, for example a conveyor belt system. During melting of the low-purity silicon material, the door 14 is sealed closed so as to prevent unwanted air from infiltrating the rotary drum furnace 10. An oxy-fuel burner 12 is disposed in the door 14. The oxy-fuel burner 12 generates a flame 13 that extends far into the rotary drum furnace 10. Waste gases produced during melting exit through a chimney 17 provided in the door 14. A canopy 19 is used to collect and direct the waste gases through an exhaust duct 18 to a waste gas collector 20. While the rotary drum furnace 10 rotates, the oxy-fuel burner 12, the chimney 17, the canopy 19 and the exhaust duct 18 remain fixed. Of course, numerous configurations of the rotary drum furnace are possible, for example, the oxy-fuel burner 12 may not be disposed in the door 14 and may rotate along with the rotary drum furnace 10.

The melting apparatus may further include a tap hole along with a tapping spout for tapping the molten material therefrom. Referring to the embodiment of FIG. 2, at the other end of the rotary drum furnace 10 opposite the door 14, the rotary drum furnace 10 includes two tap holes with two tapping spouts 24. The tap holes may be sealed closed with carbon paste 25.

### b) Melting Low-Purity Silicon Material and Obtaining a Melt of Higher-Purity Silicon Material

Low-purity silicon material is loaded into the melting apparatus, e.g. rotary drum furnace, using a loading device, for example a conveyor belt system.

The low-purity silicon material may contain any one or any combination of the following elements: Al, As, Ba, Bi, Ca, Cd, Co, Cr, Cu, Fe, K, La, Mg, Mn, Mo, Na, Ni, P, Pb, Sb, Sc, Sn, Sr, Ti, V, Zn, Zr, O, C, and B. It may be a low-grade silicon material such as metallurgical grade silicon, silicon crusher dust, silicon hand-picked from slag, and remainders containing silicon. In the case of silicon crusher dust, it is preferable to pelletize the dust before loading it into the furnace so as to avoid the risk of explosion and the contamination by the silicon crusher dust of the higher-purity silica fumes produced during the melting thereof, and to increase the thermal transfer of the burner flame and the recovery of silicon. Such pellets can be made by mixing the silicon crusher dust with sodium silicate (liquid glass), lignin liquor, molasses or sugars, lime or any other binding substance (resin), with or without baking.

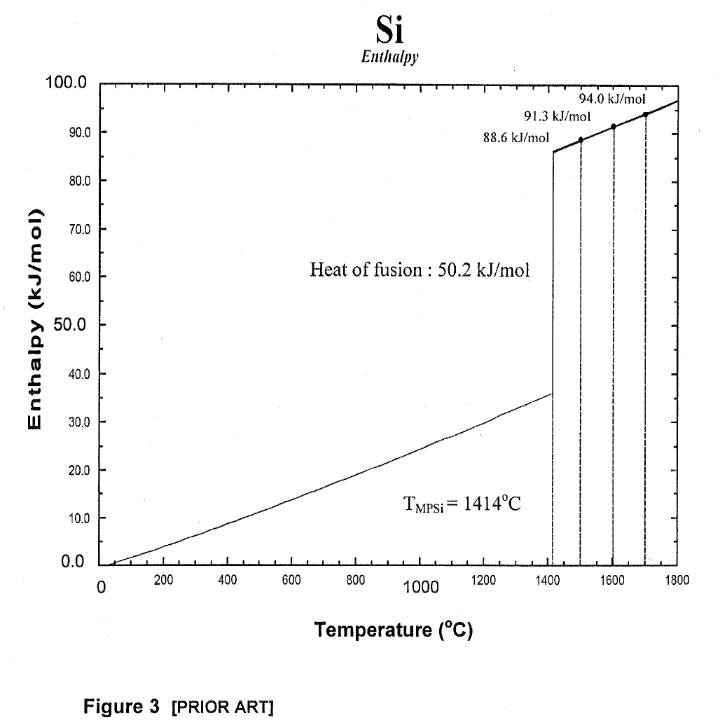

Elemental silicon melts at around 1410° C. As such, a very high temperature is needed to melt the low-purity silicon material. Melting of the low-purity silicon material is preferably carried out at a temperature in the range from about 1410° C. to 1700° C. Theoretically, the energy demand to melt silicon and bring its temperature to 1500° C. is 88.6 kJ/mol (88.6 kilojoule per mole) or 0.876 MWhr/mt (MegaWatt. Hour per metric tonne), as illustrated in FIG. 3. To facilitate the melting, the furnace may be preheated to the desired temperature and then loaded with the low-purity silicon material. Moreover, the low-purity silicon material is preferably melted at a temperature between 1410° C. and 1500° C. to precipitate carbon into a slag and reduce the oxygen content of the melt of higher-purity silicon material obtained.

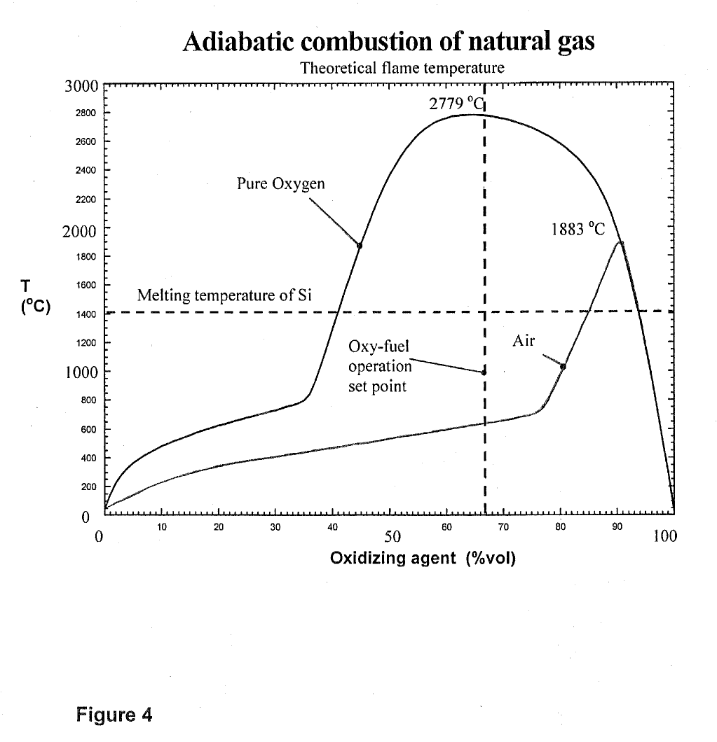

Although an air-fuel burner is theoretically capable of providing a flame temperature that is high enough to melt silicon, in fact, the large quantity of nitrogen in the air-fuel removes a lot of energy from the flame and the maximum flame temperature reached is more realistically around 1200° C. An oxy-fuel burner supplants the inefficient nitrogen in air by injecting pure oxygen directly into the flame (oxy-fuel). The maximum flame temperature provided by an oxy-fuel burner is much higher than that provided by an air-fuel burner, as can be seen in FIG. 4. The maximum flame temperature of the oxy-fuel burner is reached with approximately a 2:1 oxygen to natural gas flow.

The present method may be used to purify liquid silicon of at least one of Ca, Al, Mg, Na, K, Sr, Ba, Zn, C, O and B by changing the oxygen to fuel ratio accordingly to provide an oxidizing atmosphere.

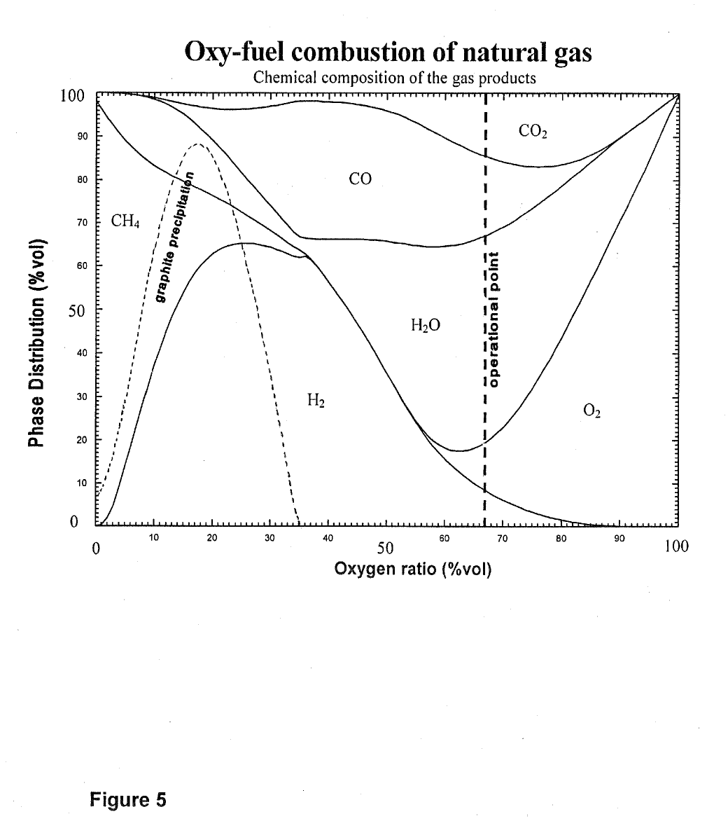

As explained in the background of the present invention, it is known in the art that silicon may be purified of boron by melting the silicon in a flow of a weakly oxidizing gas mixture of Ar—H₂—H₂O. Therefore, to remove boron from the low-purity silicon material, the melting of the low-purity silicon material in the melting apparatus (e.g. rotary drum furnace) is carried out under an oxidizing atmosphere. In the present invention, the oxy-fuel burner allows to change relatively easily the natural gas to oxygen ratio to provide an oxidizing atmosphere, be it anywhere from weakly to strongly oxidizing, through the combustion gases produced, which may include H₂O, H₂, O₂, CO and CO₂ (see FIG. 5). In fact, to provide an oxidizing atmosphere for purifying the silicon material of boron, a mixture of oxygen to natural gas in the range from 1:1 to 4:1, preferably in the range from 1.5:1 and 2.85:1 so as to also optimize the flame temperature, may be selected. The safe, controlled and relatively simple manner of providing the oxidizing atmosphere using a rotary drum furnace equipped with an oxy-fuel burner is yet another advantage of the present invention over the prior art.

To enhance the purification of the low-purity silicon material, the melt may also undergo slag treatment. A synthetic slag may be added to the melt to change the chemistry of the melt and purify the melt of specific elements. Numerous slag recipes are known in the art. For example, a synthetic slag that includes SiO₂, Al₂O₃, CaO, CaCO₃, Na₂O, Na₂CO₃, CaF, NaF, MgO, MgCO₃, SrO, BaO, MgF₂, or K₂O, or any combination thereof may be added to the molten silicon to remove Al, Ba, Ca, K, Mg, Na, Sr, Zn, C, or B, or any combination thereof from the melt.

The efficiency of slag extraction may be estimated using simplified theoretical arguments. The efficiency of the purification of boron using the slag treatment process where equilibrium is obtained between slag and silicon is given by the distribution coefficient of boron (L_{B}), defined as the ratio between the concentration of B in slag and the concentration of B in the final silicon material:

$$\begin{matrix}{L}_{B} = \frac{{[ B ]}_{slag}}{{[ B ]}_{SiMe}} & ( equation 1 ) \\ {m}_{SiMe} \cdot {[ B ]}_{SiMe}^{°} + {m}_{slag} \cdot {[ B ]}_{slag}^{°} = {m}_{SiMe} \cdot {[ B ]}_{SiMe} + {m}_{slag} \cdot {[ B ]}_{slag} & ( equation 2 )\end{matrix}$$

where
[B]⁰_{SiMe}≡initial boron content of the silicon material (ppmw)
[B]⁰_{Slag}≡initial boron content of the slag (ppmw)
[B]_{SiMe}≡final boron content of the silicon material (ppmw)
[B]_{Slag}≡final boron content of the slag (ppmw)
m_{SiMe}≡mass of silicon (kg)
m_{Slag}≡mass of slag (kg)
   and
ppmw≡parts per million by weight
kg≡kilogram.

The establishment of equilibrium between slag and silicon is rapid at the interface. Advantageously, the rotary movement of a rotary drum furnace generates new surfaces favourable for the rapid establishment of chemical equilibrium. Unlike a stationary furnace, the rotary movement of the rotary drum furnace continually exposes new surfaces of the molten material to the slag and the oxidizing atmosphere.

By substituting equation 1 into equation 2 and rearranging, the final boron content of the silicon material having undergone the slag treatment is determined:

$${[ B ]}_{SiMe} = \frac{{m}_{SiMe} \cdot {[ B ]}_{SiMe}^{°} + {m}_{slag} \cdot {[ B ]}_{slag}^{°}}{{m}_{SiMe} + {m}_{slag} \cdot {L}_{B}} \qquad ( equation 3 )$$

Using a conventional purification process (one which does not include the use of a rotary drum furnace equipped with an oxy-fuel burner) and slag treatment where the slag and silicon material under purification are allowed to reach equilibrium, the boron content in the silicon material decreases from 10 ppmw to 4.1 ppmw:

$$\begin{matrix}{L}_{B} = 17 \\ {[ B ]}_{SiMe}^{°} = 10 ppmw \\ {[ B ]}_{Slag}^{°} = 1 ppmw \\ mSiMe = 5 mt \\ {m}_{Slag} = 5 mt \\ {[ B ]}_{SiMe} = \frac{5 mt \cdot 10 ppmw + 5 mt \cdot 1 ppmw}{5 mt + 5 mt \cdot 1.7} = 4.1 ppmw\end{matrix}$$

However, considering the mass of silicon material to be purified, a large amount of slag has to be used in order to obtain a low boron content in the silicon material. A large amount of energy is needed to melt the slag. In addition, the molten slag may not be easily manipulated and may not be easily separated from the purified molten silicon material. As such, using conventional slag treatment alone to purify the silicon material is not efficient.

To be suitable for use as solar grade silicon, the boron content of the treated silicon should be less than 3 ppmw. In order to reduce the boron content in the low-purity silicon material to an acceptable low level, it is necessary to use a slag that has low boron content (e.g. a boron content less than 1 ppmw).

There are also strict requirements as to phosphorous content of solar grade silicon material. If the slag (for example, a calcium-silicate-based slag) used to remove boron from the low-purity silicon material contains too much phosphorous, the phosphorous content of silicon can be increased during slag treatment. It is thus important to use a slag that also has a low phosphorous content (e.g. a phosphorous content less than 4 ppmw P).

The following are two examples of synthetic slag recipes:

### Treatment 1 (First Melt/Impurity Extraction):

| | |
|---|---|
| Grounded quartz (SiO₂): | 700 kg/mt Si |
| Quick lime (CaO): | 150 kg/mt Si |
| Soda ash (Na₂CO₃ → Na₂O + CO₂): | 256 kg/mt Si |

### Treatment 2 (Second Melt/Impurity Extraction):

| | |
|---|---|
| Grounded quartz (SiO₂): | 800 kg/mt Si |
| Soda ash (Na₂CO₃ → Na₂O + CO₂): | 342 kg/mt Si |

With reference to Table 1, which shows the chemical composition of a plurality of synthetic slag components, a synthetic slag made of pulverized quartz and soda ash exhibits low boron and phosphorous content as required.

TABLE 1
Chemical composition of synthetic slag components

| | Quartz | Quick lime | Soda Ash |
|---|---|---|---|
| | (SiO₂) | (CaO) | (Na₂CO₃) |
| Element | (ppmw) | (ppmw) | (ppmw) |
| Al | 1046 | 2098 | 20 |
| As | <1 | 8 | <1 |
| Ba | 2 | 22 | 2 |
| Bi | 2 | 19 | <1 |
| Ca | 16 | 668700 | 66 |
| Cd | <1 | <1 | <1 |
| Co | <1 | 2 | <1 |
| Cr | <1 | 4 | <1 |
| Cu | <1 | 12 | <1 |
| Fe | 55 | 1432 | 22 |
| La | <1 | 2 | <1 |
| Mg | 24 | 3157 | 21 |
| Mn | <1 | 55 | <1 |
| Mo | <1 | <1 | <1 |
| Na | 20 | 170 | 433800 |
| Ni | <1 | 4 | <1 |
| P | <1 | 37 | 3 |
| Pb | <1 | 6 | <1 |
| Sb | 7 | 25 | <1 |
| Sc | <1 | 2 | <1 |
| Sn | 2 | 2 | <1 |
| Sr | <1 | 286 | <1 |
| Ti | 6 | 125 | <1 |
| V | <1 | 22 | <1 |
| Zn | 2 | 15 | <1 |
| Zr | <1 | 20 | <1 |
| B | <1 | 14 | 2 |

With the process of the present invention, a significant volume of silica fumes can be generated during melting of the low-purity silicon material as the material undergoes treatment. These fumes provide a source of high-purity silica and may be recovered and collected during the melting of the low-purity silicon material.

### EXAMPLES

The following non-limiting examples illustrate steps (a) through (b) of the present invention. These examples and the invention will be better understood with reference to the accompanying figures.

### Example 1

An experiment according to the process of the present invention for purifying low-purity silicon material was conducted.

A rotary drum furnace having a capacity of about 14 000 lbs (1 lbs≡453.6 grams) of liquid aluminum and equipped with an oxy-fuel burner which burns a fuel comprising natural gas and pure oxygen and which provides a power of 8 000 000 BTU/hr (BTU/hr≡British Thermal Unit per hour) was used.

The process included the steps of:
1) preheating the furnace for 3 hours at high fire;
2) melting 2.5 mt of low grade silicon (hand picked to increase the silicon content) in 3.5 hours at high fire under an oxidizing atmosphere with an oxygen gas to natural gas fuel ration of approximately 2:1;
3) tapping of the rotary drum furnace at low fire to outpour the liquid silicon;
4) cleaning the rotary drum furnace to remove the slag left behind.

### Note:

Low fire: 100 scfm oxygen and 50 scfm of natural gas
High fire: 260 scfm oxygen and 130 scfm of natural gas
1 Nm³=38.04 scf
scfm≡cubic feet per minute of gas flow at standard temperature and pressure

Table 2 below tabulates the chemical analysis of the low-purity silicon material before and after purification treatment according to the process of the present invention. It can be clearly seen that this process is particularly effective at removing aluminum, calcium, carbon and oxygen impurities from silicon.

TABLE 2
Chemical analysis of the silicon material before and after
purification treatment

| | Before | After |
|---|---|---|
| | treatment | treatment |
| Element | (%) | (%) |
| Al | 0.964 | 0.065 |
| Ca | 0.825 | 0.005 |
| Cr | 0.003 | 0.003 |
| Cu | 0.006 | 0.006 |
| Fe | 0.603 | 0.610 |
| Mn | 0.012 | 0.012 |
| Ni | 0.001 | 0.001 |
| Ti | 0.053 | 0.052 |
| V | 0.002 | 0.002 |
| C | 0.268 | 0.008 |
| O | 3.435 | <0.005 |

The cost associated with the melting (i.e. with the fuel consumption) of this process is reasonable and not prohibitive, the lower cost of oxygen gas as compared to the cost of natural gas contributing to the cost-efficiency of the process.

### Example 2

A rotary furnace equipped with an oxy-fuel burner is charged with 3500 kg of silicon material. The silicon metal is sampled prior to charging and an initial boron content is determined. The silicon material is then melted in the rotary drum furnace and under an oxidizing atmosphere with an oxygen gas to natural gas fuel ratio of approximately 2:1. When the silicon material is completely melted, a liquid sample is taken and a final boron content is determined. Analysis of the samples before and after melting confirms a lower boron concentration in the liquid silicon material following melting in the rotary drum furnace and purification according to the process of the present invention (see Table 3).

TABLE 3
Boron content of the silicon material before and after
purification

| | Initial | Final | |
|---|---|---|---|
| | Boron content | Boron content | Boron |
| Trial | (ppmw) | (ppmw) | purification (%) |
| 1 | 60 | 46 | 23% |
| 2 | 55 | 42 | 24% |
| 3 | 61 | 45 | 26% |

### Example 3

A rotary furnace equipped with an oxy-fuel burner is charged with 3500 kg of silicon metal. The silicon metal is sampled prior to charging and has a boron content of 8.9 ppmw. The silicon material is then melted in the rotary drum furnace under an oxidizing atmosphere with an oxygen gas to natural gas fuel ratio of approximately 2:1. When the silicon metal has completely melted, a liquid sample is taken at time t₀. Additional samples of the liquid silicon metal are taken from the rotary drum furnace at later times t₁, t₂, etc. Analysis of the boron content of the samples indicates that the boron content of the liquid silicon metal decreases with time, i.e. the boron content of the liquid silicon metal decreases as the liquid silicon metal is heated (see Table 4). The relationship is given by the following equation:

B(t)=B₀·e^{-0.0041·t}

where:
t is the time in minutes;
B₀ is the boron concentration in ppmw at time t₀;
B(t) is the boron concentration in ppmw at time t.

TABLE 4
Boron content over time of a heated melt of silicon material

| | | | Boron |
|---|---|---|---|
| | Time | Boron content | purification |
| | [min] | [ppmw] | [%] |
| t₀ | 0 | 5.0 | 0% |
| t₁ | 43 | 4.1 | 18% |
| t₂ | 80 | 3.6 | 28% |

Examples 1 to 3 demonstrate the particular efficiency of the process according to the present invention when it comes to purifying low-purity silicon material (e.g. low-grade silicon such as metallurgical grade silicon) of aluminum (Al), calcium (Ca), carbon (C) oxygen (O) and boron (B) impurities to provide a higher-purity silicon material (e.g. purified metallurgical grade silicon) which can be used as raw material for solar grade silicon and/or electronics grade silicon.

(c) Separating the Melt of Higher-Purity Silicon Material from a Slag

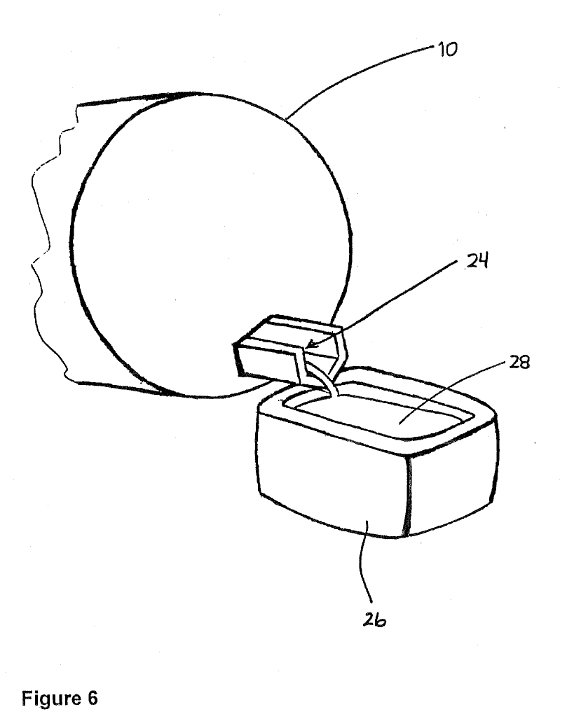

In order to separate the melt of higher-purity silicon material from a slag, the melt may be outpoured into a receiving vessel such as a mould. This may be accomplished by tapping the melting apparatus, as shown in FIG. 6. For example, an oxygen lance may be used to open a tap 24 (sealed with carbon-based mud, i.e carbon paste, in this instance) in the rotary drum furnace 10 and to allow outpouring of the melt of higher-purity silicon material 28 into a mould 26. The flow of the outpouring melt can be controlled by rotating the furnace.

(d) Further Purification of the Melt of Higher-Purity Silicon Material by Unidirectional Solidification while Electromagnetically Stirring the Melt

The melt of higher-purity silicon material obtained with the process of the present invention thus far can be further purified by unidirectional solidification while electromagnetically stirring the melt of at least one of the following elements: Al, As, Ba, Bi, Ca, Cd, Co, Cr, Cu, Fe, K, La, Mg, Mn, Mo, Na, Ni, P, Pb, Sb, Sc, Sn, Sr, Ti, V, Zn, Zr, O, C and B.

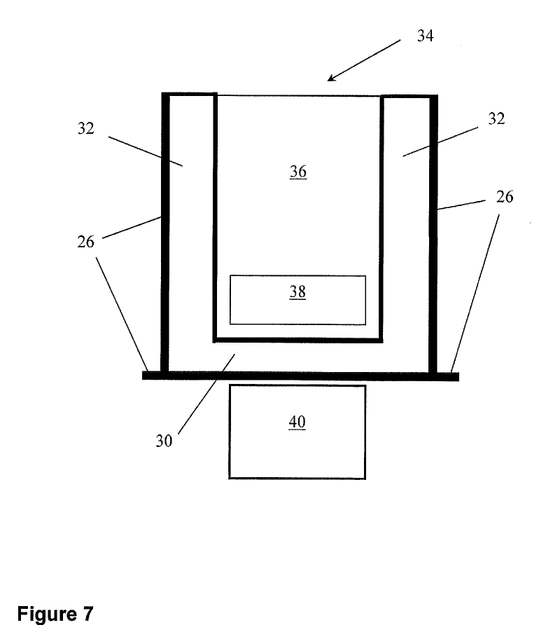

Referring to FIG. 7, the melt of higher-purity silicon material is outpoured into a mould 26 having an insulated bottom wall 30, insulated side walls 32, and an open top 34. The melt is then solidified by unidirectional solidification from the open top towards the insulated bottom wall of the mould while electromagnetically stirring the melt using an electromagnetic stirrer 40. The rate of unidirectional solidification may be controlled through the type of insulation used to insulate the bottom and side walls. The rate of unidirectional solidification may also be controlled by controlling the temperature gradient from the open top towards the insulated bottom wall of the mould—the free surface of the melt at the open top of the mould may be placed in contact with a cooling medium, for example water or air.

In accordance with one embodiment, the unidirectional solidification is stopped when the melt has partially solidified (say when 40 to 80% of the melt has solidified) to produce an ingot having an exterior shell comprising a solid polycrystalline silicon 36 having a purity higher than the higher-purity silicon material and a center comprising an impurity-enriched liquid silicon 38. An opening in the exterior shell of the ingot is created, by mechanical piercing, thermal lance, etc., to outflow the impurity-enriched liquid silicon and leave behind the exterior shell thereby obtaining solid polycrystalline silicon having a purity higher than the higher-purity silicon material.

In accordance with another embodiment, the melt of higher-purity silicon material is allowed to completely solidify. The first portion of the solid ingot to solidify contains less impurities than the remaining portion. This first portion is therefore separated from the remaining portion, using any appropriate means such as cutting, thus obtaining solid polycrystalline silicon 36 having a purity higher than the higher-purity silicon material.

Of course, the entire process—from melting in a rotary drum furnace equipped with an oxy-fuel burner to unidirectionally solidifying the melt—may be repeated using the solid polycrystalline silicon as starting material to thereby obtain a final silicon material of an even higher purity. In this way, solar grade silicon may be obtained from metallurgical grade silicon.

In view of the above description, the present invention is also directed to the higher-purity silicon material and the silica fumes obtained by melting low-purity silicon material in a melting apparatus equipped with an oxy-fuel burner according to the process of the present invention. In addition, the present invention is directed to the solid polycrystalline silicon obtained following unidirectional solidification with electromagnetic stirring of the melt of the higher purity silicon material of the present process.

In accordance with another aspect of the present invention, there is also provided a use of a rotary drum furnace equipped with an oxy-fuel burner for melting and purifying a lower purity silicon material and thereby obtaining a higher-purity silicon material.

Although embodiments of the present invention have been described in detail herein and illustrated in the accompanying drawings, it is to be understood that the invention is not limited to these precise embodiments and that various changes and modifications may be effected therein without departing from the scope or spirit of the present invention.

1. A process for purifying low-purity silicon material and obtaining a higher-purity silicon material, said process comprising the steps of:
(a) providing a melting apparatus equipped with an oxy-fuel burner; and
(b) melting the low-purity silicon material in the melting apparatus and obtaining a melt of higher-purity silicon material.

2. The process according to claim 1, wherein the melting apparatus of step (a) includes a rotary drum furnace.

3. The process according to claim 1, wherein said melting the low-purity silicon material in the melting apparatus of step (b) occurs under an oxidizing atmosphere provided by the oxy-fuel burner.

4. The process according to claim 3, wherein the oxidizing atmosphere comprises H₂O, H₂, O₂, CO and CO₂.

5. The process according to claim 3, wherein said melting of step (b) comprises setting an oxygen gas to natural gas fuel ratio in the range from 1:1 to 4:1.

6. The process according to claim 3, wherein said melting of step (b) comprises setting an oxygen gas to natural gas fuel ratio in the range from 1.5:1 to 2.85:1.

7. The process according to claim 3, wherein at least one of Na, K, Mg, C, Sr, Ba, Al, Zn, B, and C is removed from the low-purity silicon material.

8. The process according to claim 1, wherein said melting of step (b) comprises a step before step (b) of preheating the melting apparatus without the low-purity silicon material therein.

9. The process according to claim 1, wherein said melting of step (b) comprises melting the low-purity silicon material at a temperature at or above a melting temperature of silicon.

10. The process according to claim 1, wherein said melting of step (b) comprises melting the low-purity silicon material at a temperature in the range from 1410° C. to 1700° C.

11. The process according to claim 1, wherein said melting of step (b) comprises melting at a temperature between 1410° C. and 1500° C. to precipitate carbon into a slag and reduce oxygen content of the melt of higher-purity silicon material.

12. The process according to claim 1, wherein said melting of step (b) comprises adding a synthetic slag.

13. The process according to claim 1, wherein the melting of step (b) comprises collecting silica fumes produced during said melting the low-purity silicon material.

14. The process according to claim 1, further comprising a step of:
(c) separating the melt of higher-purity silicon material from a slag.

15. The process according to claim 14, wherein said separating the melt comprises outpouring the melt into a mould, said mould having an insulated bottom wall, insulated side walls, and an open top.

16. The process according to claim 15, wherein said outpouring the melt comprises tapping the melting apparatus.

17. The process according to claim 15, further comprising the steps of:
(d) solidifying the melt of higher-purity silicon material by unidirectional solidification from said open top towards said insulated bottom wall of said mould while electromagnetically stirring the melt;
(e) controlling a rate of said unidirectional solidification;
(f) stopping said unidirectional solidification when the melt has partially solidified to produce an ingot having an exterior shell comprising a solid polycrystalline silicon having a purity higher than said higher-purity silicon material and a center comprising an impurity-enriched liquid silicon; and
(g) creating an opening in said exterior shell of said ingot to outflow said impurity-enriched liquid silicon and leave behind the exterior shell thereby obtaining a solid polycrystalline silicon having a purity higher than said higher-purity silicon material.

18. The process according to claim 15, further comprising the steps of:
(d) solidifying the melt of higher-purity silicon material by unidirectional solidification while electromagnetically stirring the melt and obtaining a solid ingot;
(e) controlling a rate of said unidirectional solidification; and
(f) separating a first portion of the solid ingot from a remaining portion, said first portion having solidified before said remaining portion and comprising less impurities than the remaining portion, thus obtaining a solid polycrystalline silicon having a purity higher than said higher-purity silicon material.

19. The process according to claim 17, wherein Al, As, Ba, Bi, Ca, Cd, Co, Cr, Fe, K, La, Mg, Mn, Mo, Na, Ni, P, Pb, Sb, Sc, Sn, Sr, Ti, V, Zn, Zr, O, C, or B, or any combination thereof is removed from the low-purity silicon material.

20. Use of a rotary drum furnace equipped with an oxy-fuel burner for melting and purifying a lower purity silicon material and thereby obtaining a higher-purity silicon material.
